(19) United States
(12) Patent Application Publication
(10) Pub. No.: US 2025/0097103 A1
(43) Pub. Date: Mar. 20, 2025

(54) PROVIDING AUTOMATIC SOFTWARE UPGRADES FOR TRANSPORT LAYER DEVICES

(71) Applicant: Rakuten Mobile, Inc., Tokyo (JP)

(72) Inventors: Aaditya DHARAMPURIKAR, Indore (IN); Rahul GUPTA, Indore (IN); Aman GIRI, Indore (IN); Biplav KUMAR, Tokyo (JP); Divya KOTHARI, Indore (IN)

(21) Appl. No.: 18/002,483

(22) PCT Filed: Nov. 3, 2022
(86) PCT No.: PCT/US2022/048766

§ 371 Date: Dec. 20, 2022

(51) Int. Cl. H04L 41/082; H04L 41/084; H04L 41/22

(52) U.S. Cl. CPC H04L 41/082; H04L 41/0843; H04L 41/22

(57) ABSTRACT

Automatic software upgrades for transport layer devices is described. One or more transport layer devices from a device list for upgrading are presented on a user interface (UI). A user, via the UI, selects one or more transport layer devices from a device list for upgrading. Upgrade details for upgrading the one or more transport layer devices selected from the device list for upgrading are received via the UI. Based on the upgrade details, the upgrading of the one or more transport layer devices is initiated. Real-time information returned from the one or more transport layer device during the upgrading of the one or more transport layer devices is presented on the UI. The upgrading of the one or more transport layer devices is validated based on the real-time information.

### TECHNICAL FIELD

This description relates to a Configuration Manager (CM) User Interface (UI) for providing automatic software upgrades for transport layer devices, and method of using the same.

### BACKGROUND

The expansion of applications and data that use data and communications networks have vastly expanded. Data streaming of audio and video files and the increases in network data applications and traffic has strained the resources. The strain is further compounded by an increase in the use of Internet of Things (IoT) devices.

To support the increased network traffic, transport layer devices, such as gateways, routers, switches, and firewalls rely on vendors and operations teams to upgrade the configuration files and firmware on the devices to ensure proficient operation. Upgrades are also performed to fix software problems, and to improve security on these devices. While using wireless or Over-The-Air (OTA) methods have increased the efficiency of performing upgrades, upgrades rely on manual methods to execute the upgrades to configuration files and firmware. For example, a user manually logs onto a device and runs command line interface commands in sequence to execute an upgraded. The same manual technique is used to validate device configurations and to compare pre-upgrade and post-upgrade configurations.

In addition, users checks to ensure a device to be upgraded in not receiving network traffic. Ensuring a device is not receiving network traffic is performed using additional manual checks. A user also manually backups a configuration of a device so that the configuration of the device is able to be rolled back to the pre-upgrade configuration in response to an upgrade to a device being unsuccessful.

To upgrade multiple devices, the user has to manually perform these processes individually for the devices. These manual processes are tedious and time consuming. Upgrading multiple devices multiplies the time used for upgrading devices. The user is also not provided status information in a timely manner that results in upgrades continuing to be performed even in cases where the upgrade results in an error or invalid configuration.

### SUMMARY

In at least embodiment, a method for providing automatic software upgrades for transport layer devices, includes receiving, on a user interface (UI), selection of one or more transport layer devices from a device list for upgrading, receiving, via the UI, upgrade details for upgrading the one or more transport layer devices selected from the device list for upgrading, based on the upgrade details, initiating the upgrading of the one or more transport layer devices, presenting, on the UI, real-time information returned from the one or more transport layer device during the upgrading of the one or more transport layer devices, and validating the upgrading of the one or more transport layer devices based on the real-time information.

In at least one embodiment, a device for performing automatic software upgrades for transport layer devices includes a memory storing computer-readable instructions, and a processor connected to the memory, wherein the processor is configured to execute the computer-readable instructions to present, on a user interface (UI), one or more transport layer devices from a device list for upgrading, receive, via the UI, selection of one or more transport layer devices from a device list for upgrading, receive, via the UI, upgrade details for upgrading the one or more transport layer devices selected from the device list for upgrading, based on the upgrade details, initiate the upgrading of the one or more transport layer devices, present, on the UI, real-time information returned from the one or more transport layer device during the upgrading of the one or more transport layer devices, and validate the upgrading of the one or more transport layer devices based on the real-time information.

In at least one embodiment, a non-transitory computer-readable media having computer-readable instructions stored thereon, which when executed by a processor causes the processor to perform operations including receiving, on a user interface (UI), selection of one or more transport layer devices from a device list for upgrading, receiving, via the UI, upgrade details for upgrading the one or more transport layer devices selected from the device list for upgrading, based on the upgrade details, initiating the upgrading of the one or more transport layer devices, presenting, on the UI, real-time information returned from the one or more transport layer device during the upgrading of the one or more transport layer devices, and validating the upgrading of the one or more transport layer devices based on the real-time information.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 is a diagram of a system for performing device upgrades according to at least one embodiment.

FIG. 2 is an End to End Flow diagram of an upgrade process according to at least one embodiment.

FIG. 3 shows an example command line interface that is used for performing manual upgrades.

FIG. 4 is a diagram of a Configuration Manager User Interface (CM UI) according to at least one embodiment.

FIG. 5 is a diagram of an Upgrade Details Input UI according to at least one embodiment.

FIG. 6 is a diagram of an Upgrade History UI according to at least one embodiment.

FIG. 7 is a flowchart of a method for merging regions according to at least one embodiment.

FIG. 8 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus or device is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or data-stream or signaling-stream. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, or substantially any data-stream or signaling-stream from UE.

In at least one embodiment, a Configuration Manager (CM) User Interface (UI) performs end-to-end upgrades, and provisions real-time status checks, presents failure details, and performs configuration validation for pre-upgrade and post-upgrade operations. CM UI provides real-time tracking of data to manage any issues that occur during the upgrade process. CM UI communicates with the devices using Northbound Netconf supported applications. Upgrades are performed based on a single action performed on the CM UI.

Previous solutions relies on the user to logon to every device manually and perform the upgrade, whereas CM UI enables a user to run the upgrade process on one device or on a large number of device in parallel. CM UI handles command execution using a Netconf interface and with the help of supporting Northbound modules/applications. CM UI tracks the real-time updates from one or more devices being upgraded. CM UI provides visibility for end-to-end automation of the use case, by providing logs so that upgrade problems are solved, e.g., using debugging processes. Planned upgrades are able to be identified and canceled in the CM UI. History records of devices that are upgraded are also presented.

Embodiments described herein provide advantages over manual upgrade processes, including saving time, reducing the cost and expense of performing upgrades, and making the upgrade process easier to manage. Manual effort for upgrading devices, even with the use of scripts, is a tedious task. The CM UI also enables human resources to be conserved and provides a safeguard against human errors.

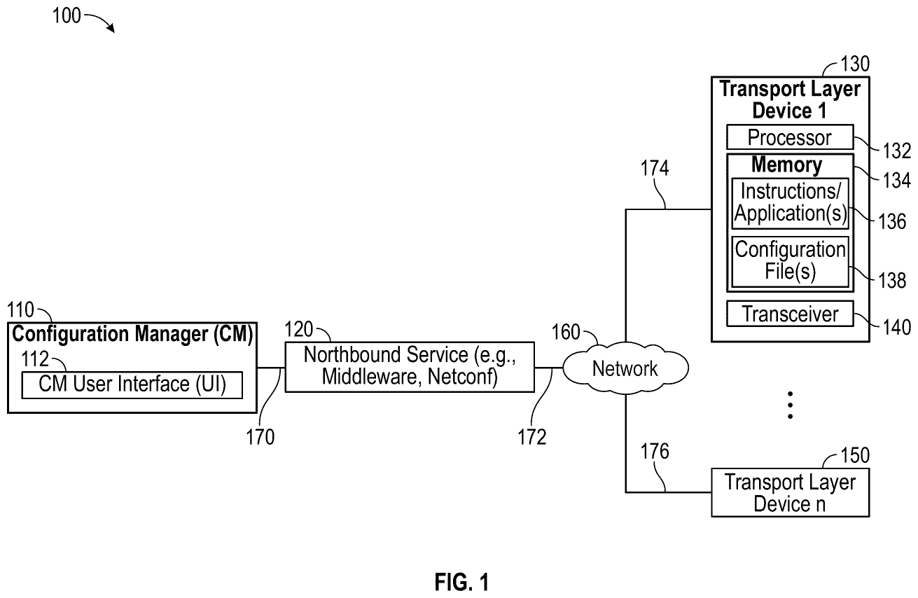

FIG. 1 is a diagram of a system 100 for performing device upgrades according to at least one embodiment.

In FIG. 1, a Configuration Manager (CM) 110 presents a CM User Interface (UI) 112 for automating upgrades to devices. CM 110 is coupled to Northbound Service 120 for interacting with Transport Layer Devices 1-n 130, 150, depending on the type of interface Transport Layer Devices 1-n 130, 150 support (e.g., Nefconf). For example, Netconf provides mechanisms to install, manipulate, delete, and upgrade configurations of transport layer devices. Northbound Service 120 is able to access Transport Layer Devices 1-n 130, 150. As an example, Transport Layer Device 1 130 includes Processor 132 and Non-Transitory Storage Media 134.

Non-Transitory Storage Media 134 includes Instructions/Applications 136 that are executable by Processor 132 to perform the functions of Transport Layer Device 1 130. Non-Transitory Storage Media 134 of Transport Layer Device 1 130 also includes Configuration Files 138. Communication is provided by Transceiver 140 to allow Transport Layer Device 1 130 to communicate with Northbound Service 120 via Network 160, as well as communicate wired or wirelessly with other devices, including Transport Layer Device n 150.

In at least one embodiment, one or more of Connections 170-176 are implemented using at least one of a wireless connection or a wired connection. In at least one embodiment, one or more of Connections 170-176 are implemented as a wireless connection in accordance with any IEEE 802.11 Wi-Fi protocols, Bluetooth protocols, Bluetooth Low Energy (BLE), or other short range protocols that operate in accordance with a wireless technology protocol for exchanging data using any licensed or unlicensed band such as the citizens broadband radio service (CBRS) band, 2.4 GHz bands, 5 GHz bands, or 6 GHz bands. Additionally, in at least one embodiment, one or more of Connections 170-176 are implemented using a wireless connection that operates in accordance with, but is not limited to, RF4CE protocol, ZigBee protocol, Z-Wave protocol, or IEEE 802.15.4 protocol. In at least one embodiment, one or more of Connections 170-176 are implemented using a coax (MoCA) network. In at least one embodiment, one or more of Connections 170-176 are a wired Ethernet connection. In at least one embodiment, one or more of Connection 170-176 are implemented as a 4G or 5G connection.

CM 110 provides a multi-vendor performance and observability framework that accesses network system data. CM User Interface (UI) 112 provides a visual presentation of the status of parameters associated with the network. The settings on CM UI 112 allows selection of Domain, Vendor, Technology. CM UI presents parameters in a network tree to view the current configuration of network elements. In at least one embodiment, CM UI 112 performs end-to-end upgrades, and provisions real-time status checks, presents failure details, and performs configuration validation for pre-upgrade and post-upgrade operations. CM UI 112 provides real-time tracking of data to manage any issues that occur during the upgrade process. CM UI 112 communicates with the Transport Layer Devices 1-n 130, 150 using Northbound Services 120 supported applications, such as Netconf applications.

Upgrades are performed based on one action performed on the CM UI 112. Previous solutions rely on the user to logon to every device manually and perform the upgrade, whereas CM UI 112 enables a user to run the upgrade process on one Transport Layer Device 130 or on a plurality of Transport Layer Devices 1-n 130, 150 in parallel. CM UI 112 handles command execution using, for example, a Netconf interface and with the help of supporting Northbound Service 120. CM UI 112 tracks the real-time updates from one or more Transport Layer Devices 1-n 130, 150 that are being upgraded.

CM UI 112 provides visibility for end-to-end automation of the use case, by providing logs so that upgrade problems are solved, e.g., using debugging processes. Planned upgrades are able to be identified and canceled in the CM UI 112. CM UI 112 further presents history records associated with upgrades of one or more of Transport Layer Devices 1-n 130, 150.

CM UI 112 provide advantages over manual upgrade processes, including saving time, reducing the cost and expense of performing upgrades, and making the upgrade process easier to be managed. Manual effort for upgrading devices, even with the use of scripts, is a tedious task. The automated upgrade process implemented using CM UI 112 enables human resources to be conserved and safeguards against human errors.

Netconf of Northbound Service 120 supports configuration data and notification data protocol operations for retrieving and editing the configuration data, for encoding remote procedure calls (RPCs) and notifications, and for providing a secure and reliable transport of messages between a client and a server. Netconf of Northbound Service 120 enables authorized users to remotely configure, manage, and monitor devices, and enables devices to proactively report alarms and events back for display in CM UI 112 in real-time.

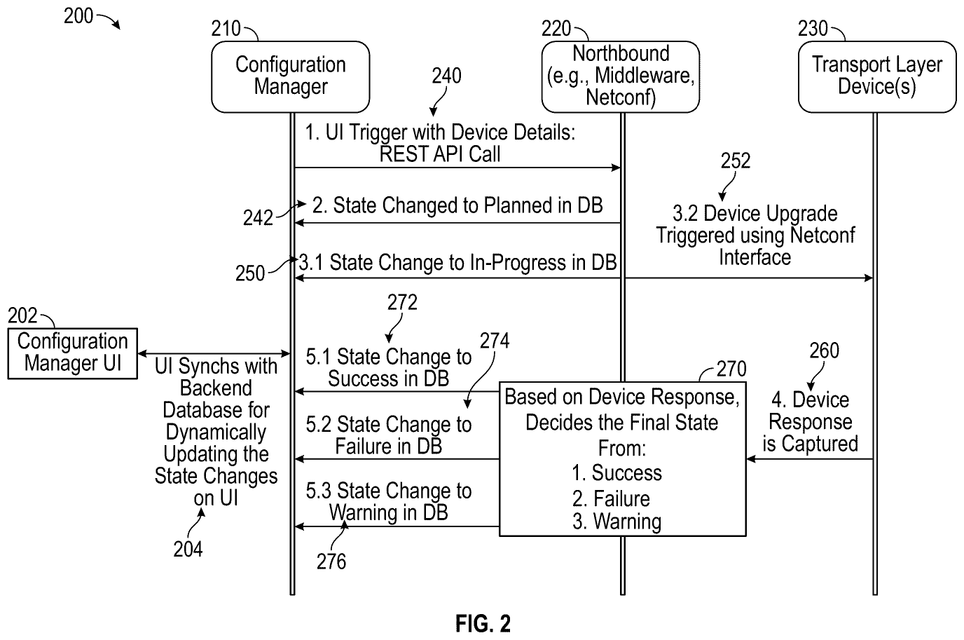

FIG. 2 is an End to End Flow diagram 200 of an upgrade process according to at least one embodiment.

In FIG. 2, CM UI 202 synchronizes with a backend database for dynamically updating state changes 204. The state changes are presented on CM UI 202. CM UI 202 is used by the user to share details related to devices and to confirm what devices to perform the upgrade. The code for executing an upgrade is based on the Northbound entity 220, which CM 210 controls. Once the details of the one or more Transport Layer Devices 230 are obtained, upgrade details, such as provided in a particular file to perform the upgrade, e.g., the operating system (OS) version, etc. are set for updating one or more Transport Layer Devices 230.

CM 210 communicates with the Northbound entity 220 in the middleware, and Northbound entity 220 communicates with one or more devices to be upgraded. Northbound entity 220 performs the upgrades to the one or more devices with the details that have been shared via the CM UI 202. The status of the processes are reflected directly on CM UI 202 using the database, state changes, logs, etc. State changes, and logs are communicated to the CM UI 202 to provide visibility of the upgrade process to the user. CM UI 202 shows the status information for the network tree. For example, CM UI 202 shows information such as devices in a planned state, an upgrade to a device is in progress, an upgrade to a device has failed, whether an upgrade to a device has been a success in the past, a warning, and other attributes.

Once the CM 210 triggers the upgrade, flow steps are managed by the Northbound entity 220, e.g., the Middleware/Netconf. CM UI 202 of CM 210 generates a trigger with device details (e.g., using a REST API call 240. Northbound entity 220 receives the details and sends a signal to change the state in the database for the one or more devices to be upgraded to “Planned” 242. When the upgrade begins, Northbound entity 220 changes the state in the database to “In-Progress” 250. The upgrade to the one or more Transport Layer Devices 230 is triggered 252 using the Netconf interface of Northbound entity 220.

Transport Layer Devices 230 captures a response associated with the upgrade 260 that is provided to Northbound entity 220. Based on the response from the one or more Transport Layer Devices 230, Northbound entity 220 determines the final state, e.g., success, failure, warning 270. Based on the final state determined by Northbound entity 220, Northbound entity 220 changes the state to “Success” in the database 272, changes the state to “Failure” in the database 274, or changes the state to “Warning” in the database 276.

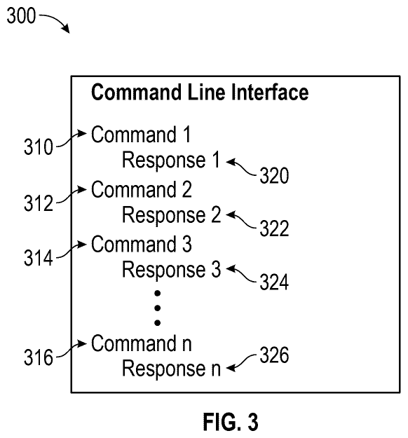

FIG. 3 shows an example command line interface 300 that is used for performing manual upgrades.

To upgrade the devices, the user logs on to each device through the command line interface 300. Commands 310, 312, 314, 316 are also used to perform pre-condition activities, such as remove the network traffic from that device. User further generates commands 310, 312, 314, 316 to validate the traffic going through the device has been stopped. The user enters still additional commands 310, 312, 314, 316 on the terminal command line interface 300 to configure basic settings. Commands 310, 312, 314, 316 are also entered to back up the device so that the configuration is able to be rolled back to the pre-upgrade version in response to problems arising during the upgrade process. Commands 310, 312, 314, 316 are executed.

In response to execution of the commands 310, 312, 314, 316, responses 320, 322, 324, 326 are returned. After the upgrade is completed, the configuration is manually validated using commands 310, 312, 314, 316 by comparing the pre-upgrade and post-upgrade configurations. Using scripts to execute the commands 310, 312, 314, 316 only marginally improves the time for upgrading devices. Scripts still have to be configured for the one or more devices that are going to be upgraded. Other processes, such as performing verifications, receiving real-time status feedback and validating upgrades, etc., are not automated. Further, a clear and easily interpreted visualization of the upgrade status and process is not provided through the use of scripts.

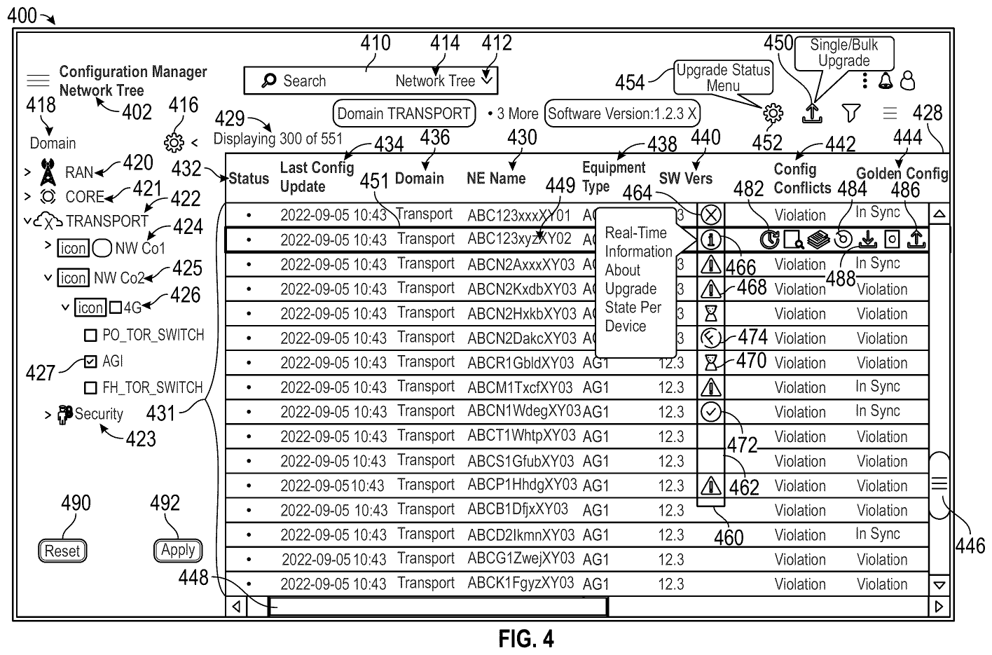

FIG. 4 is a diagram of a Configuration Manager User Interface (CM UI) 400 according to at least one embodiment.

In FIG. 4, CM UI shows the status information for the network tree 402. A Search Window 410 is provided and a drop down menu 412 enables a user to select the scope of a search, e.g., Network Tree 414. Through a Settings Icon 416, a user is able to select a view an operational Domains 418, e.g., RAN 420, Core 421, Transport 422, Security 423, etc. In FIG. 4, Domain 418 of Transport 422 is shown as being selected. Under Transport 422 further selections are available, e.g., NW Co1 424, NW C02 425. As an example, under NW Co2 424, 4G 426 is selected. Under 4G 426, AG1 427 is selected. A Window 428 presents the results based on the selections made under Transport 422. In FIG. 4, Window 428 shows “300 of 551” 429 network elements identified by Network Element (NE) Name 430. For example, sixteen (16) devices 431 are shown for provisioning in Window 428 of CM UI 400.

Window 428 also includes a column for Status 432, a date and time for the Last Configuration (Config) Update 434, identification of the Domain 436, identification of the Equipment Type 438, identification of the Software (SW) Version 440, identification of Config Conflicts 442, and status of Golden Config parameters 444. An Up/Down Navigation Bar 446 and a Left/Right Navigation Bar 448 is provided to navigate in Window 428.

In FIG. 4, a Single or Bulk Upgrade is able to be selected. To upgrade one device, the user select a row 451, e.g. NE element ABC123xyzXY02 449 identified by NE Name 430, and initiate the upgrade for that device. To upgrade multiple devices in a trigger event, the user is able to select the Bulk Upgrade Icon 450 menu option. Thus, CM UI 400 is able to execute multiple upgrades, including logging on to each device, whereas in the manual method, the user logs on to the devices one-by-one. Once an upgrade is selected, CM UI 400 automatically makes a backup of the devices selected for the upgrade and traffic is stopped at devices selected for the upgrade.

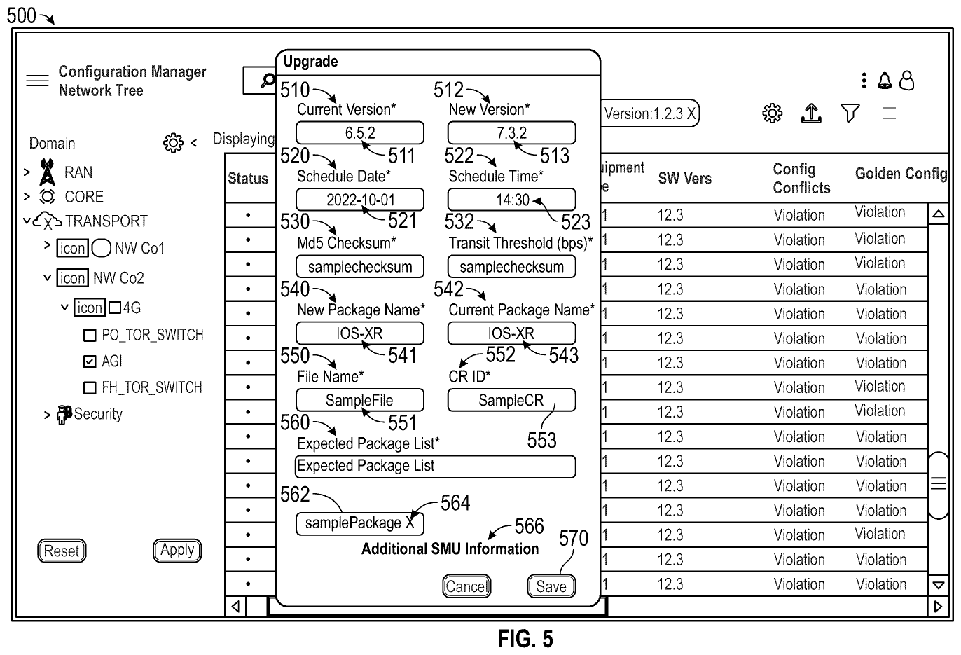

Once the device details are obtained by CM UI 400, the user selects an upgrade file having the upgrade details for performing the upgrade (see FIG. 5 for selection of the upgrade file). For example, an upgrade file provides the CM UI 400 data such as the operating system (OS) version.

CM UI 400 communicates with the Northbound entity in the middleware, and Northbound entity communicates with one or more devices to be upgraded. Northbound entity performs the upgrades to the one or more devices with the details that have been provided via the CM UI 400. The status of the processes are reflected directly on CM UI 400 using the database, state changes, logs, etc. The state changes, and the logs are communicated to the CM UI 400 to provide visibility of the upgrade process to the user.

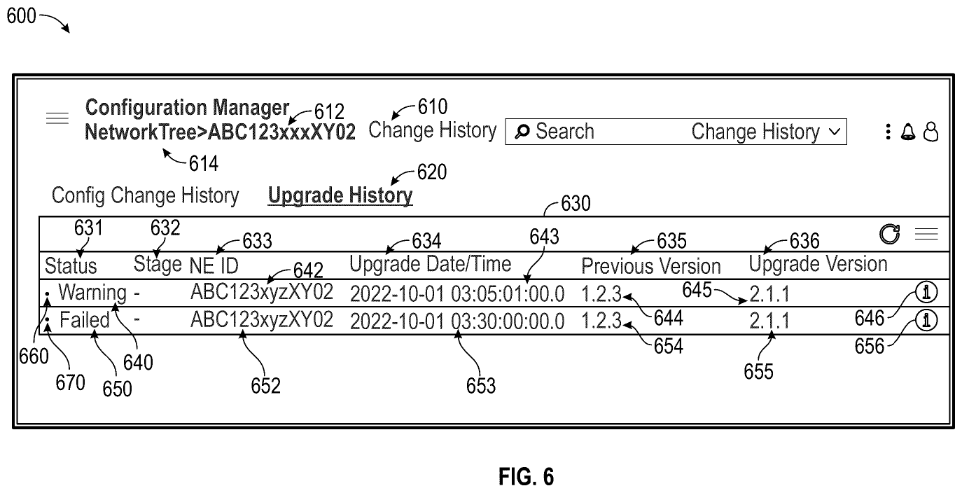

Selection of Settings Icon 452 displays an Upgrade Status Menu 454. As shown in FIG. 4, Real-Time Information 460 about the upgrade state of the devices is presented. CM UI 400 provides information that is generated by running logs with updates to Real-Time Information 460 associated with the upgrade process for devices. The user is able to see the exact stage at which a NE is currently in during the upgrade process. Real-Time Information 460 of CM UI 400 shows the upgrade status so the user is able to validate that traffic associated with the selected devices has stopped. A user is able to identify NEs where the upgrade process failed. The user is then able to select a NE element to check what exactly is wrong with the upgrade process for a selected device by clicking on the NE. Selecting a device displays Upgrade History UI 600 of FIG. 6.

CM UI 400 enables the user to cancel a planned upgrade. An upgrade is also able to be canceled by removing an upgrade from Upgrade Schedule 484. For example, in response to a user having scheduled an upgrade to a number of devices, the schedule upgrade for selected devices is able to be canceled. For example, in response to a user having scheduled an upgrade to a number of devices, the schedule upgrade for selected devices is able to be canceled. For example, some devices shown in the planning state 462.

The cross, “X” 464, shows that an upgrade for the device has been canceled. Real-Time Information 460 also includes Information Icon 466, which is able to be selected to obtain information about the upgrade to the device. Warning Icon 468 indicates an upgrade is in a warning state. Once the start the time has occurred, the state changes to “in-progress.” Hourglass Icon 470 shows that an upgrade is in progress. After the upgrade has completed, the status will be displayed as “success” or “failure.” Check Mark Icon 472 represent a successful upgrade. Failure Icon 474 represents upgrade to a device has failed.

After the upgrade is completed, CM UI 400 validates the pre- and post-configurations. In response to a mismatch between the pre- and post-configurations being determined, an alarm, e.g., Warning Icon 468, is presented on the CM UI 400. For example, there might be some new features that are not upgraded. The user is able to determine whether the mismatch is acceptable and continue with the upgrade, or to select Rollback Icon 482 to roll the configuration back to pre-update status.

In FIG. 4, network element ABC123xyzXY02 449 is shown selected. Additionally, function icons are shown for network element ABC123xyzXY02 449, e.g., Rollback 482, Upgrade Scheduled 484, Upload 486, and Download 488. The user is able to select Reset Icon 490 to roll back the upgrade. The user is able to select Apply Icon 492 to apply the upgrade after reviewing the real-time status information presented in Window 428.

Vendors and users are able to perform configuration Push from CM UI 400 directly and visualize the execution information. The CM UI 400 uses configuration files that are provided by the user (as described in FIG. 5 below). In at least one embodiment, the configuration files are provided in a JSON-format using template data provided by the user.

CM UI 400 enables a user to perform end-to-end upgrades, provides real-time status checks, presents failure details, and performs configuration validation for pre-upgrade and post-upgrade operations. CM UI 400 provides real-time tracking of data to manage any issues that occur during the upgrade process. CM UI 400 communicates with the devices using Northbound Netconf supported applications. CM UI 400 performs upgrades based on one action performed on the CM UI 400. With manual solutions, the user logs on to each device manually and perform the upgrade, whereas CM UI 400 enables a user to run the upgrade process on one device or on a large number of device in parallel.

CM UI 400 handles command execution using a Netconf interface and with the help of supporting Northbound modules/applications. CM UI 400 tracks the real-time updates from one or more devices being upgraded. CM UI 400 provides visibility for end-to-end automation of the use case, by providing logs so that upgrade problems are solved, e.g., using debugging processes. Planned upgrades are able to be identified and canceled in the CM UI 400. History records of devices that are upgraded are also presented.

CM UI 400 supports single device upgrades where upgrades are performed on one device. The user provides the upgrade related details through an Upgrade Details Input UI 500 of FIG. 5. Bulk device upgrades are similar to the single device upgrade feature, but with selection of multiple devices and selection of the Bulk Upgrade Icon 450.

Real-Time Information 460 provides the real-time state of the device which is schedules/ongoing an upgrade. CM UI 400 automatically performs upgrade to transport layer devices without any human intervention and provides real-time tracking data to manage any issues that occur during the upgrade process. CM UI 400 provides visibility for end-to-end automation of the use case, by providing logging for debugging purposes in case of issues occurring during the upgrade process. Thus, the user is provided improved visibility and control over the upgrade process using CM UI 400.

Planned upgrades are able to be canceled through CM UI 400. CM UI also provides for many pre and post upgrade checks/validation activities, which usually takes significant effort using manual methods. CM UI 400 works with many types of transport layer devices and with a Northbound module, such as a Northbound module that supports Netconf applications. CM UI 400 communicates with the devices that are to be upgraded using a Northbound supported Netconf application. For example, in at least one embodiment, execution of automated commends provided by CM UI 400 is performed by a Netconf interface and Northbound Services.

FIG. 5 is a diagram of an Upgrade Details Input UI 500 according to at least one embodiment.

In FIG. 5, Upgrade Details Input UI 500 is used to provide the details of the upgrade. Current Version 510 is pulled from the device to be upgraded. Current Version 510 is shown as 6.5.2 511. New Version 512 identifies the upgrade to provision to the device. New Version 512 is shown as 7.3.2 513. Schedule Date 520 and Schedule Time 522 provide a data and time for scheduling the upgrade. Schedule Date 520 is shown as Oct. 1, 2022 521 and Schedule Time 522 is shown as 14:30 523.

Md5 Checksum 530 is provided for the file that the user selects for performing the upgrade. Transit Threshold 532 is associated with the network traffic validation, e.g., to determine whether network traffic has been stopped.

New Package Name 540 identifies the name of the upgrade package to be used. In FIG. 5, New Package Name 540 is shown as IOS-XR 541. Current Package Name 542 identifies the name for the current configuration. In FIG. 5, Current Package Name 542 is shown as IOS-XR 543. Other package names for New Package Name 540 and Current Package Name 542 are able to be displayed, e.g., NX-OS, IOS XE, etc. For example, an upgrade is able to be made from IOS XR to IOS XE.

File Name 550 is for identifying the name of the upgrade file that is used for the upgrade. In FIG. 5, File Name 550 is identified as sampleFile 551. Control Relationship Identifier (CR ID) 552 identifies a control relationship between a control point and a controller. In FIG. 5, CR ID 552 is identified as sampleCR 553.

Expected Package List 560 is used to list packages that are candidates for the upgrade. A sample package is shown as samplePackage 562. The user is able to reject samplePackage 562 by clicking on “X” 564. Additional details and metadata are able to be selected or entered by clicking Additional SMU Information 566.

After the upgrade details are entered on the Upgrade Details Input UI 500, the user Selects the Save Button 570. The upgrade begins, and progress information is presented in real-time on CM UI 400 of FIG. 4.

FIG. 6 is a diagram of an Upgrade History UI 600 according to at least one embodiment.

Once an upgrade is selected in CM UI 400 of FIG. 4, Upgrade History UI 600 is displayed. Upgrade History UI 600 provides the upgrade history data for a device so the user is able to determine how many times the device has been upgraded, when the device was upgraded, etc. For example, Upgrade History UI 600 shows a device that has been upgraded twice.

In FIG. 6, Change History 610 for ABC123xxxXY02 612 in Network Tree 614 is shown. Upgrade History UI 600 is identified as Upgrade History 620. Upgrade History UI 600 is able to show upgrade history of devices, wherein a device includes multiple upgrades, e.g., 0-20 upgrades.

Window 630 includes columns for Status 631, Stage 632, NE ID 633, Upgrade Date/Time 634, Previous Version 635 and Upgrade Version 636. Window 630 shows device having NE ID 633 of ABC123xxxXY02 612 with 2 upgrades 660, 670.

Upgrade 660 is the most recent upgrade history for ABC123xxxXY02 612 and has a Status 631 of Warning 640. The NE ID 632 is shown as ABC123xxxXY02 642. The Upgrade Time/Date 633 is shown as “2022 Oct. 1 03:05:01:00.0” 643. The change in version associated with the upgrade is displayed. The Previous Version 634 is shown as1.2.3 644 and the Upgrade Version 635 is shown as 1.1.1. 645.

Upgrade 670 is the next upgrade history for ABC123xxxXY02 612 and has a Status 631 of Failed 650. The NE ID 632 is shown as ABC123xxxXY02 652. The Upgrade Time/Date 633 is shown as “2022 Oct. 1 01:30:00:00.0” 653. The change in version associated with upgrade 670 is displayed. The Previous Version 634 is shown as1.2.3 654 and the Upgrade Version 635 is shown as 1.1.1. 655.

Selection of Information Icons 646, 656 displays further details associated with Upgrades 660, 670, respectively.

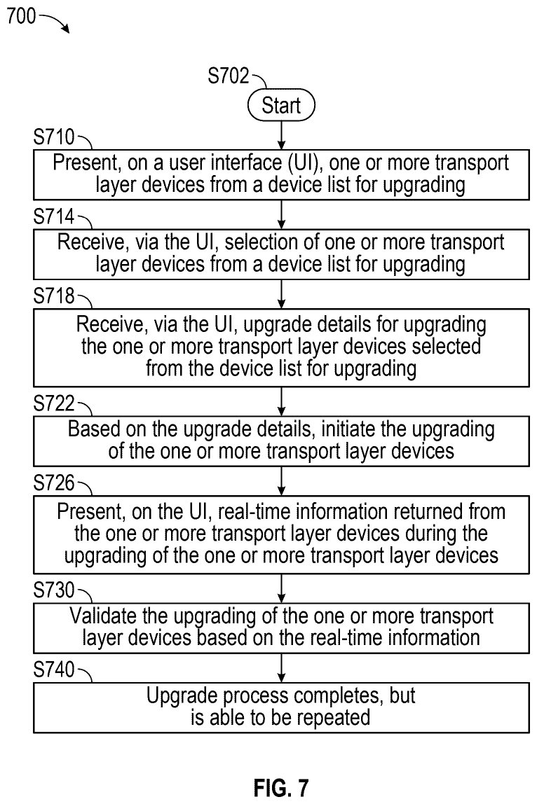

FIG. 7 is a flowchart 700 of a method for merging regions according to at least one embodiment.

In FIG. 7, the upgrade process begins and one or more transport layer devices from a device list for upgrading are presented on a user interface UI S710.

A selection of one or more transport layer devices is received, via the UI, from a device list for upgrading S714. The selection of the one or more devices includes logging on to the one or more devices selected from the device list for upgrading, making a backup of the one or more device selected from the device list for upgrading, and halting network traffic at the one or more device selected from the device list for upgrading.

Upgrade details for upgrading the one or more transport layer devices selected from the device list for upgrading is received via the UI S718. The upgrade details includes a schedule for initiating the upgrading of the one or more transport layer devices. A user is able to cancel the upgrading of at least one of the one or more transport layer devices.

Based on the upgrade details, the upgrading of the one or more transport layer devices is initiated S722.

Real-time information returned from the one or more transport layer device during the upgrading of the one or more transport layer devices is presented on the UI S726. The real-time information includes state changes and logs, identification of configuration conflicts, a status of configuration parameters associated with the one or more devices selected from the device list for upgrading. The real-time information also includes an alarm for at least one of the one or more transport layer devices in response to determining a mismatch between the pre-upgrade configuration and post-upgrade configuration. A user is able to provide input to cause a roll back of the post-upgrade configuration upgrade of the at least one of the one or more transport layer devices associated with the alarm to the pre-upgrade configuration.

The upgrading of the one or more transport layer devices is validated based on the real-time information S730. The validating incudes, based on the real-time information, receiving a selection of a failed device identified as having failed the upgrading and displaying an upgrade history associated with the failed device.

The upgrade process completes, but is able to be repeated S740.

At least one embodiment of the method for providing automatic software upgrades for transport layer devices includes receiving, on a user interface (UI), selection of one or more transport layer devices from a device list for upgrading, receiving, via the UI, upgrade details for upgrading the one or more transport layer devices selected from the device list for upgrading, based on the upgrade details, initiating the upgrading of the one or more transport layer devices, presenting, on the UI, real-time information returned from the one or more transport layer device during the upgrading of the one or more transport layer devices, and validating the upgrading of the one or more transport layer devices based on the real-time information.

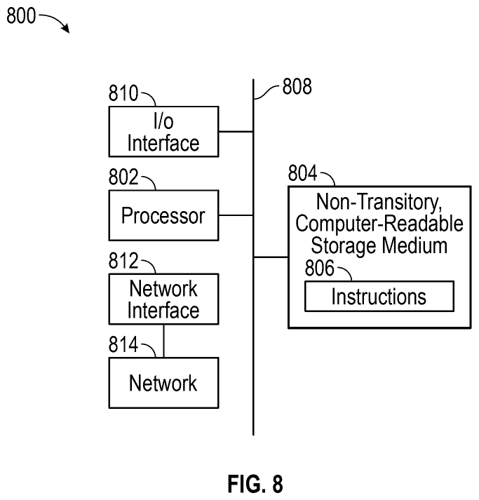

FIG. 8 is a high-level functional block diagram of a processor-based system 800 according to at least one embodiment.

In at least one embodiment, processing circuitry 800 provides automatic software upgrades for transport layer devices. Processing circuitry 800 implements automatic software upgrades for transport layer devices using processor 802. Processing circuitry 500 also includes a non-transitory, computer-readable storage medium 804 that is used to implement automatic software upgrades for transport layer devices. Storage medium 804, amongst other things, is encoded with, i.e., stores, instructions 806, i.e., computer program code that are executed by processor 802 causes processor 802 to perform operations for providing automatic software upgrades for transport layer devices. Execution of instructions 806 by processor 802 represents (at least in part) an application which implements at least a portion of the methods described herein in accordance with one or more embodiments (hereinafter, the noted processes and/or methods).

Processor 802 is electrically coupled to computer-readable storage medium 804 via a bus 808. Processor 802 is electrically coupled to an Input/output (I/O) interface 810 by bus 808. A network interface 812 is also electrically connected to processor 802 via bus 808. Network interface 812 is connected to a network 814, so that processor 802 and computer-readable storage medium 804 connect to external elements via network 814. Processor 802 is configured to execute instructions 806 encoded in computer-readable storage medium 804 to cause processing circuitry 800 to be usable for performing at least a portion of the processes and/or methods. In one or more embodiments, processor 802 is a Central Processing Unit (CPU), a multi-processor, a distributed processing system, an Application Specific Integrated Circuit (ASIC), and/or a suitable processing unit.

Processing circuitry 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

Processing circuitry 800 also includes network interface 812 coupled to processor 802. Network interface 812 allows processing circuitry 800 to communicate with network 814, to which one or more other computer systems are connected. Network interface 812 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 800 is configured to receive information through I/O interface 810. The information received through I/O interface 810 includes one or more of instructions, data, design rules, libraries of cells, and/or other parameters for processing by processor 802. The information is transferred to processor 802 via bus 808. Processing circuitry 800 is configured to receive information related to a User Interface (UI) through I/O interface 810.

In one or more embodiments, one or more non-transitory computer-readable storage media 804 having stored thereon instructions (in compressed or uncompressed form) that are used to program a computer, processor, or other electronic device) to perform processes or methods described herein. The one or more non-transitory computer-readable storage media 804 include one or more of an electronic storage medium, a magnetic storage medium, an optical storage medium, a quantum storage medium, or the like.

For example, the computer-readable storage media include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 804 includes a Compact Disk-Read Only Memory (CD-ROM), a Compact Disk-Read/Write (CD-R/W), and/or a Digital Video Disc (DVD).

In one or more embodiments, storage medium 804 stores computer program code 806 configured to cause processing circuitry 800 to perform at least a portion of the processes and/or methods for providing automatic software upgrades for transport layer devices. In one or more embodiments, storage medium 804 also stores information, such as algorithm which facilitates performing at least a portion of the processes and/or methods for providing automatic software upgrades for transport layer devices. Accordingly, in at least one embodiment, the processor circuitry 800 performs a method for providing automatic software upgrades for transport layer devices.

The process for providing automatic software upgrades for transport layer devices includes receiving, on a user interface (UI), selection of one or more transport layer devices from a device list for upgrading, receiving, via the UI, upgrade details for upgrading the one or more transport layer devices selected from the device list for upgrading, based on the upgrade details, initiating the upgrading of the one or more transport layer devices, presenting, on the UI, real-time information returned from the one or more transport layer device during the upgrading of the one or more transport layer devices, and validating the upgrading of the one or more transport layer devices based on the real-time information.

The process for providing automatic software upgrades for transport layer devices provides at least the advantages of saving time, reducing the cost and expense of performing upgrades, and making the upgrade process easier to manage. Manual effort for upgrading devices, even with the use of scripts, is a tedious task. The CM UI also enables human resources to be conserved and reduces human errors made in performing an upgrade. Separate instances of these programs are executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above are able to be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for providing automatic software upgrades for transport layer devices, comprises:
receiving, on a user interface (UI), selection of one or more transport layer devices from a device list for upgrading;
receiving, via the UI, upgrade details for upgrading the one or more transport layer devices selected from the device list for upgrading;
based on the upgrade details, initiating the upgrading of the one or more transport layer devices;
presenting, on the UI, real-time information returned from the one or more transport layer device during the upgrading of the one or more transport layer devices; and
validating the upgrading of the one or more transport layer devices based on the real-time information.

2. The method of claim 1, wherein the presenting the real-time information includes receiving state changes and logs, identification of configuration conflicts, a status of configuration parameters associated with the one or more devices selected from the device list for upgrading.

3. The method of claim 2, wherein the presenting the real-time information includes displaying an alarm for at least one of the one or more transport layer devices in response to determining a mismatch between a pre-upgrade configuration and a post-upgrade configuration, and receiving input to roll back the post-upgrade configuration upgrade of the at least one of the one or more transport layer devices associated with the alarm to the pre-upgrade configuration.

4. The method of claim 1, wherein the receiving the selection of the one or more devices includes logging on to the one or more devices selected from the device list for upgrading, making a backup of the one or more device selected from the device list for upgrading, and halting network traffic at the one or more device selected from the device list for upgrading.

5. The method of claim 1 further comprising, based on the real-time information, receiving a selection of a failed device identified as having failed the upgrading and displaying an upgrade history associated with the failed device.

6. The method of claim 1, wherein the receiving the upgrade details for upgrading the one or more transport layer devices includes receiving a schedule for initiating the upgrading of the one or more transport layer devices.

7. The method of claim 6, wherein the receiving the schedule for initiating the upgrading of the one or more transport layer devices includes receiving a cancelation of the upgrading of at least one of the one or more transport layer devices.

8. A device for performing automatic software upgrades for transport layer devices, comprising:
a memory storing computer-readable instructions; and
a processor connected to the memory, wherein the processor is configured to execute the computer-readable instructions to:
present, on a user interface (UI), one or more transport layer devices from a device list for upgrading;
receive, via the UI, selection of one or more transport layer devices from the device list for upgrading;
receive, via the UI, upgrade details for upgrading the one or more transport layer devices selected from the device list for upgrading;
based on the upgrade details, initiate the upgrading of the one or more transport layer devices;
present, on the UI, real-time information returned from the one or more transport layer device during the upgrading of the one or more transport layer devices; and
validate the upgrading of the one or more transport layer devices based on the real-time information.

9. The device of claim 8, wherein the processor is further configured to present the real-time information by presenting state changes and logs, identification of configuration conflicts, a status of configuration parameters associated with the one or more devices selected from the device list for upgrading.

10. The device of claim 9, wherein the processor is further configured to present the real-time information by displaying an alarm for at least one of the one or more transport layer devices in response to determining a mismatch between a pre-upgrade configuration and a post-upgrade configuration, and receiving input to roll back the post-upgrade configuration upgrade of the at least one of the one or more transport layer devices associated with the alarm to the pre-upgrade configuration.

11. The device of claim 8, wherein the processor is further configured to receive the selection of the one or more devices by logging on to the one or more devices selected from the device list for upgrading, making a backup of the one or more device selected from the device list for upgrading, and halting network traffic at the one or more device selected from the device list for upgrading.

12. The device of claim 8, wherein the processor is further configured to, based on the real-time information, receive a selection of a failed device identified as having failed the upgrading, and display an upgrade history associated with the failed device.

13. The device of claim 8, wherein the processor is further configured to receive the upgrade details for upgrading the one or more transport layer devices by receiving a schedule for initiating the upgrading of the one or more transport layer devices.

14. The device of claim 13, wherein the processor is further configured to receive the schedule for initiating the upgrading of the one or more transport layer devices by receiving a cancelation of upgrading of at least one of the one or more transport layer devices.

15. A non-transitory computer-readable media having computer-readable instructions stored thereon, which when executed by a processor causes the processor to perform operations comprising:
receiving, on a user interface (UI), selection of one or more transport layer devices from a device list for upgrading;
receiving, via the UI, upgrade details for upgrading the one or more transport layer devices selected from the device list for upgrading;
based on the upgrade details, initiating the upgrading of the one or more transport layer devices;
presenting, on the UI, real-time information returned from the one or more transport layer device during the upgrading of the one or more transport layer devices; and
validating the upgrading of the one or more transport layer devices based on the real-time information.

16. The non-transitory computer-readable media of claim 15, wherein the presenting the real-time information includes receiving state changes and logs, identification of configuration conflicts, a status of configuration parameters associated with the one or more devices selected from the device list for upgrading.

17. The non-transitory computer-readable media of claim 16, wherein the presenting the real-time information includes displaying an alarm for at least one of the one or more transport layer devices in response to determining a mismatch between a pre-upgrade configuration and a post-upgrade configuration, and receiving input to roll back the post-upgrade configuration upgrade of the at least one of the one or more transport layer devices associated with the alarm to the pre-upgrade configuration.

18. The non-transitory computer-readable media of claim 15, wherein the receiving the selection of the one or more devices includes logging on to the one or more devices selected from the device list for upgrading, making a backup of the one or more device selected from the device list for upgrading, and halting network traffic at the one or more device selected from the device list for upgrading.

19. The non-transitory computer-readable media of claim 15 further comprising, based on the real-time information, receiving a selection of a failed device identified as having failed the upgrading and displaying an upgrade history associated with the failed device.

20. The non-transitory computer-readable media of claim 15, wherein the receiving the upgrade details for upgrading the one or more transport layer devices includes receiving a schedule for initiating the upgrading of the one or more transport layer devices.
